(19) United States
(12) Patent Application Publication
(10) Pub. No.: US 2010/0108255 A1
(43) Pub. Date: May 6, 2010

(54) Method For Making an Article of Armor

(76) Inventor: Jamin Micarelli, Kirkland, WA (US)

Correspondence Address: PATRICK M. DWYER PC, 14419 Greenwood Avenue N #322, SEATTLE, WA, 98133, US

(21) Appl. No.: 12/558,404

(22) Filed: Sep. 11, 2009

Related U.S. Application Data
(60) Provisional application No. 61/095,957, filed on Sep. 11, 2008.

(51) Int. Cl. B29C 65/10

(52) U.S. Cl. 156/286

(57) ABSTRACT

A method of using a hot isostatic press to make an article of armor is disclosed. A plurality of fiber layers interposed with a plurality of resin layers is laid in the hot isostatic press as a layered combination. An omnidirectional pressure is applied to the layered combination, and the combination is degassed as the pressure is applied.

This application claims priority to U.S. Provisional 61/095,957, filed Sep. 11, 2008.

This invention relates generally to materials, and more specifically, to systems and methods for providing resin reinforced fiber for use in armor. Specific details of certain embodiments of the invention are set forth in the following description to provide a thorough understanding of such embodiments. The present invention may have additional embodiments, may be practiced without one or more of the details described for any particular described embodiment, or may have any detail described for one particular embodiment practiced with any other detail described for another embodiment.

In one embodiment, the invention includes a process for manufacturing resin reinforced fiber for use in armor. The process first includes the step of stacking at least one fiber layer and at least one resin layer and disposing the stacked fiber layer and resin layer in a press cavity of an isostatic press. In one particular embodiment, the press is constructed as described and illustrated within U.S. Provisional Patent Application 61/068,964, which is hereby incorporated by reference in its entirety as if fully set forth herein; although, any other isostatic press is employable. In a further particular embodiment, the fiber layer is composed of KEVLAR 29 having a thickness of approximately 0.43 mm, a tow thickness of approximately 1500 denier, a tow-weave tightness of approximately 24×24 warp/fill (yarns per inch), a fabric weight of approximately 9.8 oz/yd², and a break strength of approximately 1100 warp lbf/in and 1200 lbf/in for the fill; although, any other fiber or material is employable. In yet another particular embodiment, the resin layer is composed of film polycarbonate having a thickness of approximately 0.5 mils, a tensile strength greater than approximately 40 MPa, and a Shore D hardness of approximately 120 or greater; although, any resin or material is employable. The stacked fiber layer and resin layer can optionally be sealed within a vacuum bag, such as an embossed thermo-sealed vacuum bag, to facilitate initial removal of gasses, such as air, from the stacked fiber layer and resin layer. In yet a further embodiment, a plurality of fiber layers and resin layers are alternately stacked with the tows of adjacent fiber layers being either parallel, perpendicular, or differently aligned with one another. In one particular embodiment, eight fiber layers are interposed with six resin layers to yield a relative amount of approximately 70% fiber to 30% resin and an overall thickness of approximately 0.112 inches. Many other combinations of fiber and resin are possible. In an alternate embodiment, the fiber layer is disposed within the press and is sprayed, painted, or vacuum infused with the resin.

Next, the process includes the step of closing the press and applying an initial degassing pressure to the stacked fiber layer and resin layer while the press approaches the glass transition temperature of the resin. In one particular embodiment, the initial degassing pressure is approximately 60 psi and the approached glass transition temperature of the resin is approximately 345° F. The initial degassing pressure serves to facilitate removal of any gasses that are produced as a result of the resin approaching the glass transition temperature; however, this step can optionally be omitted.

Once the press reaches the glass transition temperature of the resin, pressure applied to the stacked fiber layer and resin layer is increased and uniformly applied by the isostatic press. Uniformly is intended to mean equal pressure to every side of the stacked fiber layer and resin layer; although uniformly also includes equal pressure to approximately every side of the stacked fiber layer and resin layer. In one particular embodiment, the pressure is increased to approximately 3,500 psi, but pressure can be increased less or even further such as to anywhere below approximately 44,000 psi. In another embodiment, the pressure is uniformly applied using a liquid, solid, or gas medium, such as silicone, argon, nitrogen, or water, which surrounds the stacked fiber layer and resin layer by filling the negative space within the press. In another particular embodiment only partial pressure is applied.

The increased uniformly applied pressure and the glass transition temperature are sustained for a given duration. In one particular embodiment, the given duration is approximately five minutes, but this can be increased or decreased as desired. As a result of the increased uniform pressure and the glass transition temperature, the resin is forcibly infiltrated between, around, and through individual tows of the fiber to completely encase and infiltrate the tows of the fiber with resin. Although, in certain embodiments the resin only partially encases or infiltrates the tows of the fiber.

Next, while still under increased uniform pressure, the fiber and resin are rapidly cooled, wherein the resin is solidified between, around, and through the tows of the fiber to form a composite composed of fiber and resin. Cooled is intended to mean an approach to room temperature and not necessarily chilling. In one particular embodiment, the fiber and resin are rapidly cooled by applying cold water to the press for a period of approximately five minutes. In another particular embodiment, the fiber and resin are more slowly cooled. In a further particular embodiment, the pressure is changed, such as decreased, before or while the fiber and resin are cooled. The composite is then removed from the press and optionally finished. In one particular embodiment, the finishing includes trimming, such as by hand, router, or CNC machine.

The composite is usable as or in armor by itself or in conjunction with other composite materials, such as SPECTRA SHIELD. With the resin infiltrated into the fiber and disposed between, around, and through individual tows of the fiber, the resin is configurable to deform with the fiber as opposed to delaminate from the fiber upon impact by a projectile. In one particular embodiment, the composite has a durometer between approximately 80 Shore D to 200 Shore D.

### BRIEF DESCRIPTION OF THE DRAWINGS

FIG. 1 is a schematic diagram of the structure of KEVLAR

FIG. 2 is a schematic diagram of the structure of Nylon 4,6

### BEST MODE

In one particular embodiment, the resin reinforced fiber composite defines an elongated rollable sheet. A manufacturer is configurable to remove a desired amount of resin reinforced fiber composite from the elongated sheet and cut the same into a desired shape to produce customized armor. In one particular embodiment, the resin reinforced fiber composite is further coated in a resin that is later usable to bond the resin reinforced fiber composite into a larger composite.

In various other embodiments, the fiber is composed of any high strength fiber that has a heat tolerance sufficient to resist the heat used to melt the resin, such as a glass fiber; a ceramic fiber such as boron carbide, alumina oxide, silicone carbide; a loose weave KEVLAR fiber; an aramid fiber; a liquid crystal polymer fiber; a carbon fiber; a graphite fiber; PBO such as ZYLON, polyethylene, vinylon; another similar fiber; or a combination of fibers that is woven, knotted, unidirectional, or otherwise constructed to permit infiltration of resin.

In other embodiments, the resin is composed of any thermoplastic having a high strength to weight ratio, such as polyphthalamide, R-polyphenylsulfone, polysulfone, polyamide-imide, sulfone, polyphenylene, polyetheretherketone, polyamide, nylon, polyethylene, polyurethane, polycarbonate, acrylic, nylon, nylon 4, 6, nylon 6,6, polystyrene, polycaprolactam, liquid crystal polymer, a thermosetting polyurethane, epoxy, polyester, rubber, UV curing resin, another similar thermoplastic, or a combination of the foregoing.

In one embodiment, the following interaction equation can predict relative resin to fiber bond strengths. This interaction equation is not required in order to practice other embodiments disclosed herein and in some cases may not adequately predict the suitability of a particular resin for use in a composite of resin and fiber.

The interaction equation is (b/n)(1+p) where b is the length of smallest repeat unit (pm); n is the number of hydrogen bond points per repeat unit; and p is the number of non-planar elements (sp³ hybridized atoms). In order to achieve a number for easy comparison, the output can be normalized to Kevlar by dividing by 331.25. Smaller interaction values can be indicative of a greater ability to form hydrogen bonds and provide a stronger resin to fiber bond.

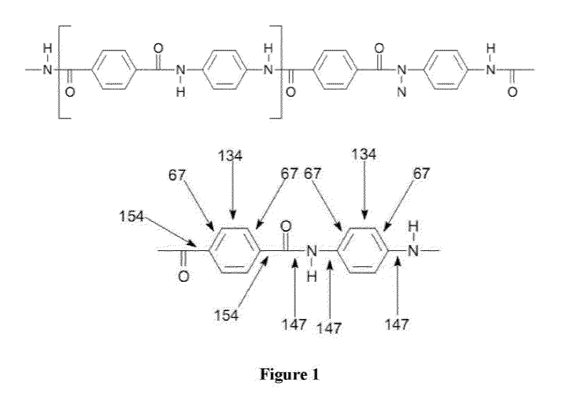

To provide an example of using the interaction equation, the structure of KEVLAR is provided in FIG. 1 with the smallest repeat unit shown in brackets and the length of each covalent radius is summed along the chain (units are picometers, 10⁻¹²m). See further Table 1 below.

TABLE 1

| | C | N | O | P | S |
|---|---|---|---|---|---|
| Single Bond | 77 | 70 | 66 | 110 | 104 |
| Double Bond | 67 | 61 | 57 | 100 | 94 |
| Triple Bond | 60 | 55 | 52 | | |

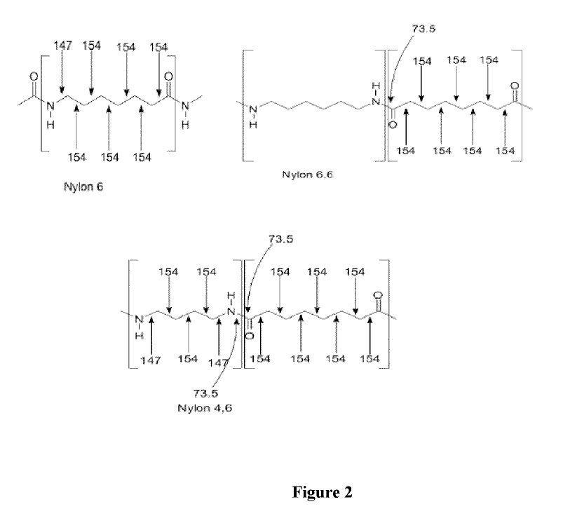

The bond length for benzene consists of two numbers, 134 pm and 67 pm. The 134 pm length is the sum of two doubly bonded carbon atoms while the 67 pm length is due to the axial component of the 134 pm length (Cos(60)=0.5). The amide linkage is conjugated, forcing the amine group into a planar arrangement, restricting its ability to rotate thereby resulting in 0 non-planar elements. Using these values in our equation an interaction value of (1285/4)(1+0)/331.25=1.03. In certain embodiments, when copolymers are used, the interaction value is the average of the interaction value for all polymers used. For instance (FIG. 2), Nylon 4,6 has an interaction value of 7.39, the average of the 4 carbon chain interaction value of 5.16 and the 6 carbon chain interaction value of 10.75. During cases of averaging, one half of the length of the bond joining the two monomers, the C—N of the amide group in this case, can be added to the length of each monomer. In other embodiments, constitutional isomers, molecules of the same formula that differ in the order in which their atoms are connected, can be treated differently with the lowest interaction value of the set being used for all structures. For instance, Nylon 6,6 has an interaction value of 20.73 and Nylon 6 has an interaction value of 9.70, so the interaction value of 9.70 can be used.

The interaction equation can be usable with various resins to determine suitability for use in a resin reinforced fiber. In one embodiment, aromatic polyesters such as polycarbonate, polyethylene terephthalate (PET), polytrimethylene terephthalate and polybutylene terephthalate (PBT) having interaction values less than approximately 15 can be suitable resins. In another embodiment, polyurethanes, such as polyether, polyester, aromatic polyether, or aromatic polyester urethane, with interaction values from approximately 2 to approximately 400 and preferably from approximately 2 to approximately 50 can be suitable for use as resins. In one particular embodiment, because chain extenders and high molecular weight polyols increase the interaction value, polyurethane made from fewer flexible groups having a lower molecular weight, such as between approximately 100 and approximately 1000, can be usable as a resin.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments.

I claim:

1. A method of using a hot isostatic press to make an article of armor, the method comprising:
a) laying a plurality of fiber layers in the hot isostatic press, a plurality of the plurality of fiber layers interposed therebetween with at least one resin layer to form a layered combination;
b) applying an omnidirectional pressure to the layered combination; and
c) degassing the layered combination as the pressure is applied.
